(19) United States
(12) Patent Application Publication
(10) Pub. No.: US 2008/0141219 A1
(43) Pub. Date: Jun. 12, 2008

(54) MULTIPLE INHERITANCE FACILITY FOR JAVA SCRIPT LANGUAGE

(76) Inventor: Roberto R. Chinnici, Santa Clara, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/937,319

(22) Filed: Nov. 8, 2007

Related U.S. Application Data
(60) Provisional application No. 60/869,282, filed on Dec. 8, 2006.

(51) Int. Cl. G06F 9/44

(52) U.S. Cl. 717/116

(57) ABSTRACT

A system and method of creating a class with multiple inheritance including invoking a create class function, creating new function, creating list of prototypes and a list of superprototypes, creating a new prototype, storing a result in list of prototypes, creating a new superprototype, storing the new superprototype in the list of superprototypes when the list of superprototypes is not empty. The method further includes creating a reverse order iterative method, selecting a first prototype and calling an initialization method when the initialization method is present in the selected prototype and creating the initialization method when the initialization method is not present in the selected prototype and assigning the selected initialization method to a list of initialization methods.

### CROSS REFERENCE TO RELATED APPLICATIONS

This application claims priority from U.S. Provisional Patent Application No. 60/869,282 (Attorney Docket SUNMP743+), filed on Dec. 8, 2006 and entitled “Module Facility and Multiple Inheritance Facility for Java Script Language,” which is incorporated herein by reference in its entirety for all purposes. This application is related to U.S. patent application Ser. No. 11/930,707 (Attorney Docket SUNMP743), filed on Oct. 31, 2007 and entitled “Module Facility for Java Script Language,” which is incorporated herein by reference in its entirety for all purposes

### BACKGROUND

The present invention relates generally to scripting programming languages, and more particularly, to methods and systems for programming in the JavaScript language.

The JavaScript language is not the same as the more well known Java programming language. The JavaScript language is one implementation of the ECMAScript standard as specified in the ECMA-262 promulgated by the European Computer Manufacturer's Association. The JavaScript language is commonly used in client applications such as an Internet browser (e.g., Microsoft Internet Explorer, Mozilla, etc.). The JavaScript language is not a compiled language and therefore can be easily modified and used without the need of a compiler or a compiling process.

The JavaScript language is typically used for writing relatively simple applications that are used in a client computer or client applications. However, there are some functions allowed in JavaScript language that are desirable to use when programming more complex applications such as for use on a server.

Unfortunately The JavaScript language can be difficult to use to write very complex software because the JavaScript language does not include an inheritance capability. Further, the JavaScript language also lacks modularity. Further still, the JavaScript language does not have a built-in module/package facility. In view of the foregoing, there is a need for an improved JavaScript language.

### SUMMARY

Broadly speaking, the present invention fills these needs by providing JavaScript language extensions. It should be appreciated that the present invention can be implemented in numerous ways, including as a process, an apparatus, a system, computer readable media, or a device. Several inventive embodiments of the present invention are described below.

One embodiment provides a method of creating a class with multiple inheritance including invoking a create class function, creating new function, creating list of prototypes and a list of superprototypes, creating a new prototype, storing a result in list of prototypes, creating a new superprototype, storing the new superprototype in the list of superprototypes when the list of superprototypes is not empty. The method further includes creating a reverse order iterative method, selecting a first prototype and calling an initialization method when the initialization method is present in the selected prototype and creating the initialization method when the initialization method is not present in the selected prototype and assigning the selected initialization method to a list of initialization methods.

The initialization method can be operative to automatically call a first property of the selected prototype. The method can also include selecting a subsequent prototype when there is at least one additional prototype to analyze.

The method can also include inputting a list of objects, specifying a property name and inputting the specified property name to a get function, selecting an element from a list of objects, returning a value of the specified property when the selected element includes the specified property and selecting a subsequent element to analyze when the selected element does not include the specified property and additional elements in list of objects remain to be analyzed. The method can further include returning an error when there are no additional elements in list of objects remain to be analyzed. The method can be a JavaScript method.

Another embodiment provides a computer system including a processor and a memory system coupled to the processor by a data bus. The computer system can also include logic for invoking a create class function, logic for creating new function, logic for creating list of prototypes, logic for creating list of superprototypes, logic for creating a new prototype, logic for storing result in list of prototypes, logic for creating a new superprototype, logic for storing the new superprototype in the list of superprototypes when the list of superprototypes is not empty, logic for creating a reverse order iterative method, logic for selecting a first prototype and logic for calling an initialization method when the initialization method is present in the selected prototype and creating the initialization method when the initialization method is not present in the selected prototype and logic for assigning the selected initialization method to a list of initialization methods.

The computer system can also include logic for inputting a list of objects, logic for specifying a property name and inputting the specified property name to a get function, logic for selecting an element from a list of objects, logic for returning a value of the specified property when the selected element includes the specified property and selecting a subsequent element to analyze when the selected element does not include the specified property and additional elements in list of objects remain to be analyzed.

The computer system can further include a JavaScript language development environment. The computer system can further include a library including functions, prototypes and superprototypes.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 shows a relationship of multiple levels of modules, in accordance with an embodiment of the present invention.

FIG. 2A is a flowchart diagram that illustrates the method operations performed in searching for and executing a module, in accordance with an embodiment of the present invention.

FIG. 2B is the table of executed modules, in accordance with an embodiment of the present invention

FIG. 2C is a simplified block diagram of a system including the table of executed modules, in accordance with an embodiment of the present invention.

FIG. 3 is a block diagram of an exemplary computer system for carrying out the processing according to the invention.

FIG. 4A is a flowchart of the method operations for creating a class, in accordance with an embodiment of the present invention.

FIG. 4B is a block diagram of an object, in accordance with an embodiment of the present invention.

FIG. 4C is a block diagram of an object, a JSAdapter object and the parent objects, in accordance with an embodiment of present invention.

FIG. 5 is a flowchart of the method operations for creating a class, in accordance with an embodiment of the present invention.

FIG. 6 is a flowchart of additional method operations for creating a class, in accordance with an embodiment of the present invention.

FIG. 7 is a flowchart of additional method operations for dynamically calling a method, in accordance with an embodiment of the present invention.

### DETAILED DESCRIPTION

Several exemplary embodiments for an improved JavaScript language will now be described. It will be apparent to those skilled in the art that the present invention may be practiced without some or all of the specific details set forth herein.

As described above, the existing versions of the JavaScript language can be difficult to write complex software in due to the lack of inheritance, the lack of modularity and because the Javascript language does not have a built-in module/package facility. The prior versions of the JavaScript language do not have a built-in class facility and therefore cannot support multiple inheritance. While the foregoing invention is described in terms of the JavaScript language the invention could also be implemented in other languages implemented under the ECMAScript standard as specified in the ECMA-262.

Due to the prototype-based nature of JavaScript and the fact that the prototype used for an object is tied to the constructor function that created it, library authors have used techniques such as property-copying that do not offer the full power of multiple inheritance. The lack of inheritance requires the software author to write multiple copies of code segments that are commonly used throughout the application. Any changes to the commonly used code segments must then be made to each and every instance of the code segments which can be a difficult, complex and time consuming task in even a fairly rudimentary JavaScript application.

### Modular Facility for JavaScript Language

By taking advantage of some additional functionality added to the JavaScript engine, a module facility for JavaScript can be created with the following characteristics:

1) Modules include a namespace in which named objects can be defined by the application and/or library vendor.

2) Modules are isolated from each other.

3) Access to a module does not require any special import-like statement to be entered beforehand.

4) Modules are resolved and loaded on demand by the system, without application intervention.

5) Module search paths are fully configurable.

6) Modules can be organized hierarchically, i.e. a module can have sub-modules, which in turn can have sub-modules of their own.

The extension described herein can be specifically used with the Mozilla Rhino JavaScript engine, however, similar extensions could allow substantially the same functionality with any version of the JavaScript engine.

The above characteristics provide a very convenient module facility for developers. A module is loaded on-demand the first time that an application attempts to use it, without requiring any import-like statements (e.g., special syntax or declarations or preambles) to be used.

One embodiment includes a JSAdapter object and a bidirectional JavaScript-Java bridge provided by the JavaScript implementation in Java SE 6 to create an object that acts as a root object for a module hierarchy. De-referencing a property of this root object causes the corresponding module to be loaded and registered into the system. As a result, a dot-notation for property access can be used to access the objects contained in the module. By iterating this construction, hierarchies of modules can also be supported.

Each module includes a module definition file. The module definition file contains a top-level call to a function that installs the module in the correct place in a module tree. The JSAdapter facility provides the needed functionality.

A module also includes a namespace in which named objects can be defined by the application and/or library vendor. The namespace for each module have a defined structure and format of names.

Modules can be isolated from each other. Isolating the modules limits the access of one module to another. The isolation can also increase the robustness of the modules.

Java and many other software languages typically require a special import statement to call and load all required classes before the application can be instantiated. One embodiment of the present invention does not require any special import-like statement to be entered before execution of the application.

Java and many other software languages typically require distinct operations of loading and importing and execution operation of each of the objects. One embodiment of the present invention does not require such separate loading, importing and execution operation for each of the modules. When the modules are referenced (e.g. as part of a function call) the module is automatically loaded and executed.

Module search paths are fully user definable. While many other software languages typically require the objects to be in precise directory structure, in one embodiment a user (i.e., a programmer) can define the directory structure as desired or as may be convenient for the specific JavaScript language application being developed. The user defined search path includes the directory structure where all of the modules can be located.

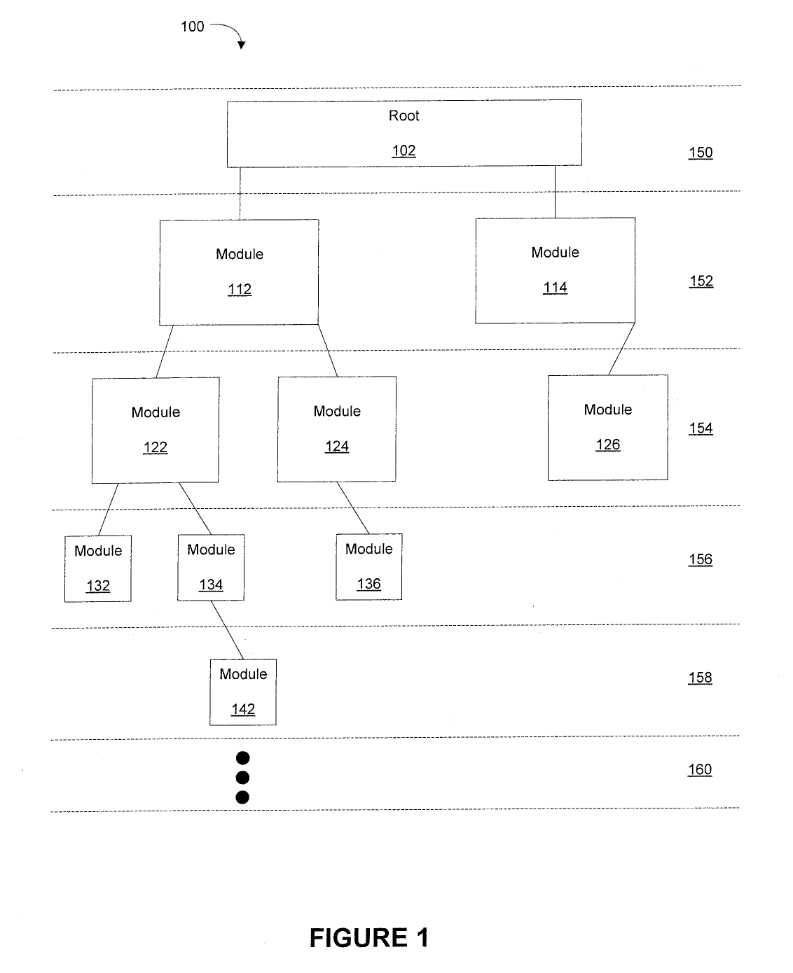

FIG. 1 shows a relationship 100 of multiple levels of modules 112-142, in accordance with an embodiment of the present invention. Modules 112-142 can be organized hierarchically, with top level modules 112, 114 linked to a root 102. Each of the modules 112, 114 in the top level 152 can have one or more sub-levels of sub-modules 122, 124 and 126, respectively in a lower level 154. The sub-modules 122, 124 and 126 can have yet additional layers 156, 158 of sub-sub-modules 132-142, respectively. The number of levels 152-160 of modules 112-142 is not specifically restricted. Further, each level 152-160 of modules can include one or more modules 112-142.

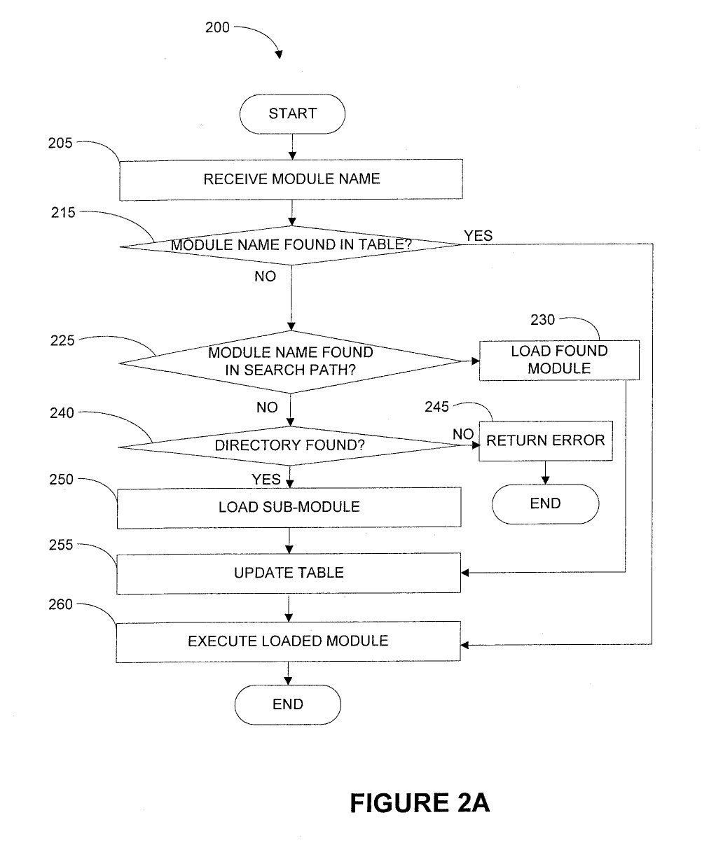

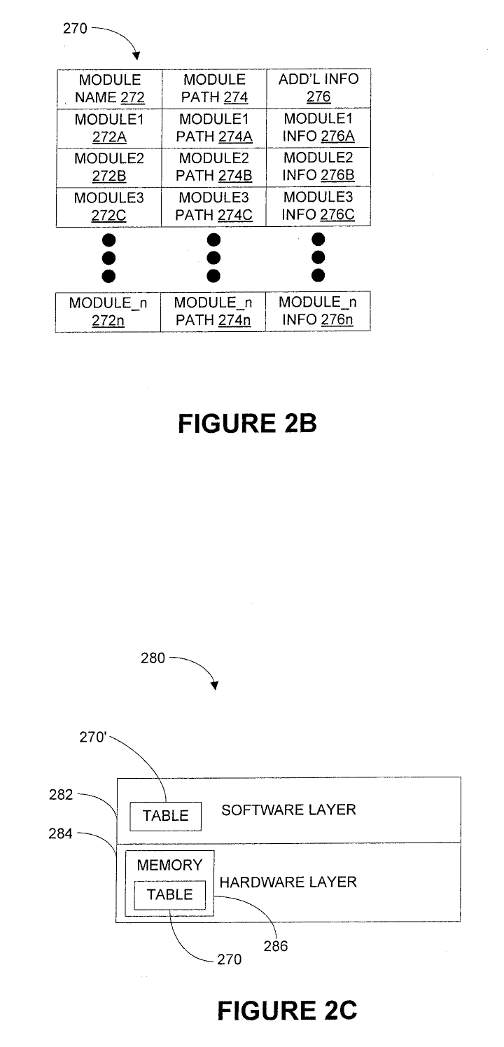

FIG. 2A is a flowchart diagram that illustrates the method operations 200 performed in searching for and executing a module 112-142, in accordance with an embodiment of the present invention. FIG. 2B is the table of executed modules 270, in accordance with an embodiment of the present invention. During the execution of a JavaScript language application, a module name can be called for execution as any other executable object. When the module name is called for execution, in an operation 205, a new “get” instruction queries a table of executed modules 270, in an operation 215.

The table of executed modules 270 includes a list of modules 272 including the names of the executed modules 272A-n. The table of executed modules 270 also includes a cross-reference 274 for each of the modules 272A-n of the corresponding path or location 274A-n in the search path for each of the respective module.

For example, a path might be [“/framework/library”, “/application/library”]. This is a 2-element array containing two strings, which identify two locations or directories in which module files might reside.

The table of executed modules 270 can also include additional information 276A-n about each of the executed modules as will be described in more detail below. For example, the table of executed modules can include, for each module, a timestamp associated with the file that the module was loaded from. The timestamp can be used when an application accesses an already executed module. The timestamp can be used to check that the executed module is current by comparing the timestamp with that of the file. This way, a user may modify a module as the application is running, save it to disk and have the updated version be picked up by the application without manual intervention by the user.

FIG. 2C is a simplified block diagram of a system 280 including the table of executed modules 270, in accordance with an embodiment of the present invention. The system 280 includes the system hardware layer 284 and the application layer 282 residing on the hardware layer. It should be understood that the system 280 can include additional hardware and software components. By way of example the system 280 can include multiple applications or multiple application layers. Further, the system 280 can include additional hardware components including peripherals, input/output devices and many other components as may be necessary to execute the applications. The table of executed modules 270, 270′ can be included in one or both of the system hardware layer 284 (e.g., in a memory 286 or any other location) and the application layer 282.

When the table of executed modules 270 is initialized, the table is empty. The table of executed modules 270 is gradually filled in with the information relating to each executed module as each executed module is called by the application. In at least one embodiment, the size of the table of executed modules 270 is not specifically limited, other than as dictated by the available memory. In alternative embodiments, the size of the table of executed modules 270 can be limited to a previously selected size. In at least one embodiment, the table of executed modules 270 is never cleared as long as the application is executing. Once the application completes execution, the memory space consumed by the table of executed modules 270 can be cleared or reused as any other memory used by the application.

Referring again to FIG. 2A, if the called module is found in the table of executed modules 270 in operation 215, then the module is returned in operation 260 as described in more detail below. If the called module is not found in the table of executed modules 270 in operation 215, then the method operations continue in an operation 225.

In the operation 225, the predefined search path is examined to determine if the called module is found in the search path. Recall above, that the application programmer defined the search path. If the called module is found in the search path, then the method operations continue in an operation 230. In operation 230, the found module is loaded and the method operations continue in an operation 255.

In operation 255, the table of executed modules 270 is updated to include the currently found and loaded module and the method operations continue in operation 260.

In operation 260, the found and loaded module is executed and the result returned or produced. The method operations can then end.

Returning to operation 225 above, if the module is not found in the search path, then the method operations continue in an operation 240. In operation 240, the search path is examined to determine if a directory having a name including the name of the called module is found. If the directory having a name including the name of the called module is not found, then the method operations continue in an operation 245. In operation 245, an error message (e.g., an undefined error or similar error message) is returned to the calling application and the method applications can end.

If in operation 240, a directory having a name including the name of the called module is found, then the method operations continue in an operation 250. The directory can be a location for a sub module.

In operation 250, if a module having the name of the called module is found in the directory and identified as a sub-module, then the found sub-module is loaded and the method operations can continue in operation 255 as described above.

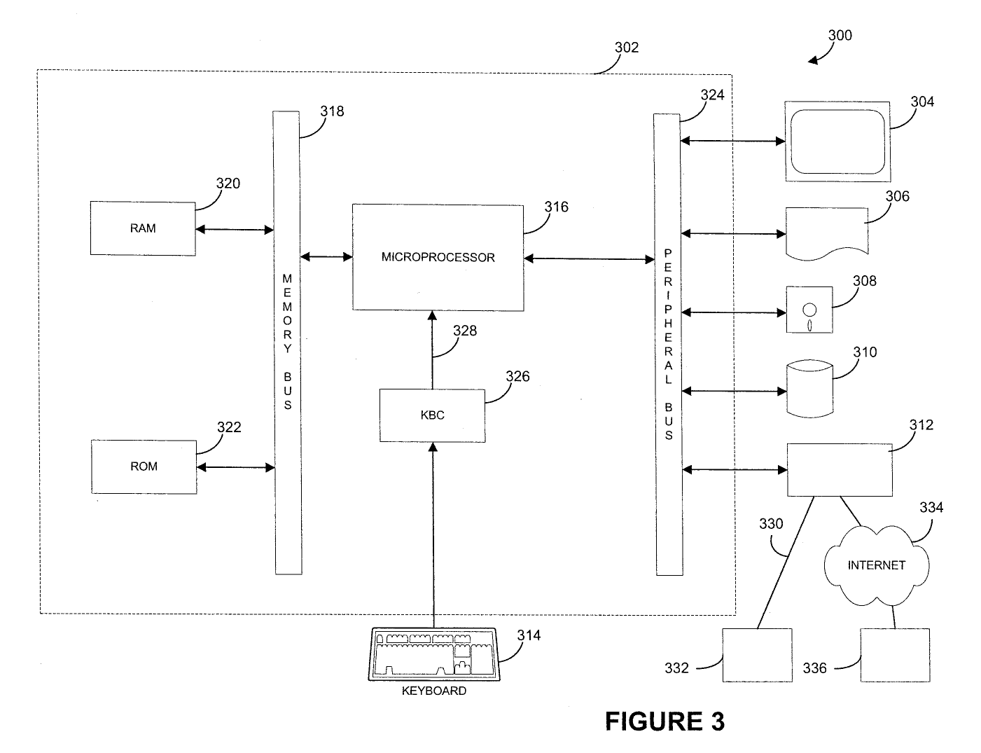

FIG. 3 is a block diagram of an exemplary computer system 300 for carrying out the processing according to the invention. The computer system 300 includes a digital computer 302, a display screen (or monitor) 304, a printer 306, a floppy disk drive 308, a hard disk drive 310, a network interface 312, and a keyboard 314. The digital computer 302 includes a microprocessor 316, a memory bus 318, random access memory (RAM) 320, read only memory (ROM) 322, a peripheral bus 324, and a keyboard controller (KBC) 326. The digital computer 302 can be a personal computer (such as an IBM compatible personal computer, a Macintosh computer or Macintosh compatible computer), a workstation computer (such as a Sun Microsystems or Hewlett-Packard workstation), or some other type of computer.

The microprocessor 316 is a general purpose digital processor, which controls the operation of the computer system 300. The microprocessor 316 can be a single-chip processor or can be implemented with multiple components. Using instructions retrieved from memory, the microprocessor 316 controls the reception and manipulation of input data and the output and display of data on output devices.

The memory bus 318 is used by the microprocessor 316 to access the RAM 320 and the ROM 322. The RAM 320 is used by the microprocessor 316 as a general storage area and as scratch-pad memory, and can also be used to store input data and processed data. The ROM 322 can be used to store instructions or program code followed by the microprocessor 316 as well as other data.

The peripheral bus 324 is used to access the input, output, and storage devices used by the digital computer 302. In the described embodiment, these devices include the display screen 304, the printer device 306, the floppy disk drive 308, the hard disk drive 310, and the network interface 312. The keyboard controller 326 is used to receive input from keyboard 314 and send decoded symbols for each pressed key to microprocessor 316 over bus 328.

The display screen 304 is an output device that displays images of data provided by the microprocessor 316 via the peripheral bus 324 or provided by other components in the computer system 300. The printer device 306, when operating as a printer, provides an image on a sheet of paper or a similar surface. Other output devices such as a plotter, typesetter, etc. can be used in place of, or in addition to, the printer device 306.

The floppy disk drive 308 and the hard disk drive 310 can be used to store various types of data. The floppy disk drive 308 facilitates transporting such data to other computer systems, and hard disk drive 310 permits fast access to large amounts of stored data.

The microprocessor 316 together with an operating system operate to execute computer code and produce and use data. The computer code and data may reside on the RAM 320, the ROM 322, or the hard disk drive 310. The computer code and data could also reside on a removable program medium and loaded or installed onto the computer system 300 when needed. Removable program media include, for example, CD-ROM, PC-CARD, floppy disk and magnetic tape.

The network interface 312 is used to send and receive data over a network connected to other computer systems. An interface card or similar device and appropriate software implemented by the microprocessor 316 can be used to connect the computer system 300 to an existing network and transfer data according to standard protocols.

Network interface 312 typically provides data communication through one or more networks 330, 334 to other data devices. For example, network interface 312 may provide a connection through local network 330 to local server computer 332 or to a more remote computer 336 over the Internet 334. Local network 330 and Internet 334 both use electrical, electromagnetic or optical signals which carry digital data streams. The signals through the various networks and the signals on network interface 312 which carry the digital data to and from computer 302, are exemplary forms of carrier waves transporting the information.

Computer 302 can send messages and receive data, including program code, through the network(s) and network interface 312. In the Internet example, a remote server computer 336 might transmit a requested code for an application program through Internet 334 and/or local network 330.

The received code may be executed by microprocessor 316 as it is received, and/or stored in mass storage 310, or other non-volatile storage for later execution. In this manner, computer 302 may obtain application code in the form of a carrier wave. Application code may be embodied in any form of computer program product. A computer program product comprises a medium configured to store or transport computer readable code or data, or in which computer readable code or data may be embedded. Some examples of computer program products are CD-ROM disks, ROM cards, floppy disks, magnetic tapes, computer hard drives, servers on a network, and carrier waves.

The keyboard 314 is used by a user to input commands and other instructions to the computer system 300. Other types of user input devices can also be used in conjunction with the present invention. For example, pointing devices such as a computer mouse, a track ball, a stylus, or a tablet can be used to manipulate a pointer on a screen of a general-purpose computer.

### Multiple Inheritance Facility for JavaScript Language

The above modularity facility also allows the classes to have an inheritance and even multiple inheritance of properties from one or more parent classes or superclasses. The inheritance can also be dynamic. Due to language limitations present in the typical JavaScript language, multiple inheritance is not provided. One approach includes copying properties into prototypes. Copying properties into prototypes is a one-time operation and therefore any subsequent modifications of the prototypes of the object done at runtime will not be reflected in the corresponding subclasses.

A library can be created using some extensions built into the JavaScript engine. The library allows a multiple-inheritance facility for the JavaScript language without requiring copying properties. The library also provides the ability to dynamically extend the set of properties for a class after an instance of that class or one of its subclasses has been instantiated.

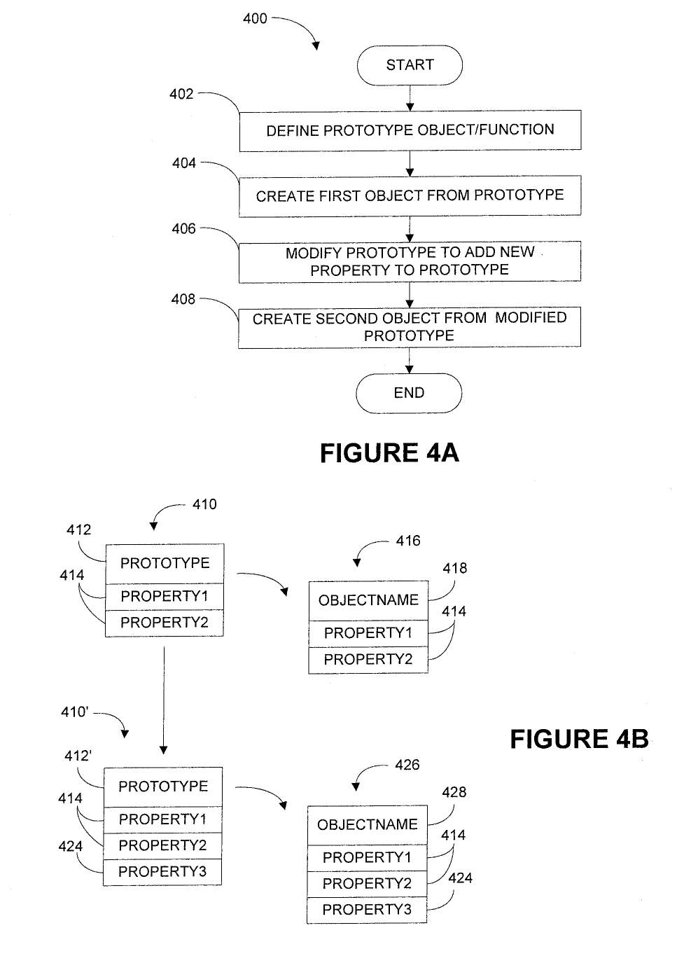

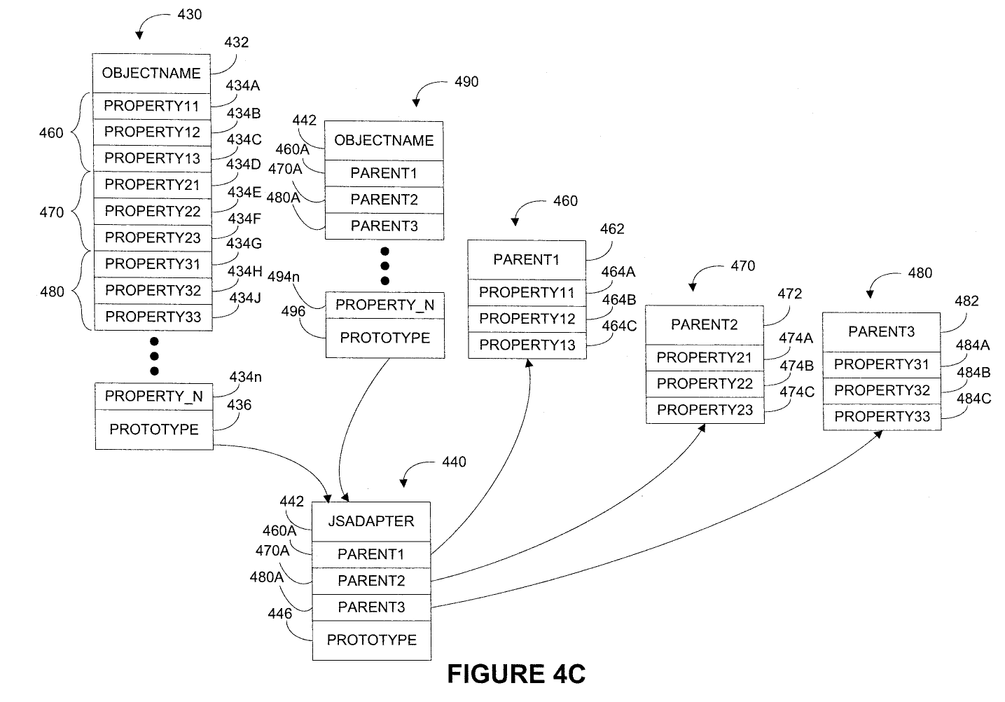

FIG. 4A is a flowchart of the method operations 400 for creating a class, in accordance with an embodiment of the present invention. FIG. 4B is a block diagram of an object 400, in accordance with an embodiment of the present invention. In an operation 402 a prototype object 410 is created. The prototype object 410 includes property1 and property2 414. In an operation 404 an object 416 is created by copying the prototype object 410. The object 416 includes an object name 418, property1 and property2 414.

In an operation 406 the prototype object 410 is modified to create modified prototype 410′. The modified prototype object 410′ includes property1 and property2 414 and property3 424. Unfortunately, creating modified prototype object 410′ by adding property3 424 does not modify or update object 416 since the object 416 was simply a copy of the prototype object 410 and is no longer linked to prototype object 410.

In an operation 408 an object 426 is created by copying the modified prototype object 410′. The object 426 includes an object name 428, property1 and property2 414 and property3 424.

As shown above a strict prototype copying process will work but is far from ideal as each of the previously created objects 416 do not automatically inherit the additions and modifications to the prototype object 410. As a result, the previously created objects 416 must be manually updated when the prototype object 410 is updated, added to or modified.

FIG. 4C is a block diagram of an object 430, a JSAdapter object 440 and the parent objects 460, 470 and 480, in accordance with an embodiment of present invention. Inheritance can be achieved by using two additions to the JavaScript language. First is the JSAdapter object 440 and the second is an ability to assign a new value to a prototype slot of an object after the object has been created. These additional functions can be used to define a class creation function that is initialized with any number of superclasses 460, 470, 480.

Internally, this function maintains a JSAdapter object 440 that contains a list of parent class identifiers 460A, 470A, 480A that correspond respectively to each of the parent classes 460, 470, 480. The JSAdapter object 440 will delegate to the parent classes 460, 470, 480 at runtime.

The JSAdapter object 440 can be copied to create objects 430, 490. Each of objects 430, 490 include an object name 432, 492, the parent classes 460, 470, 480 and other properties 434n that are included in the object. The objects 430, 490 also include the prototype name 436, 496 that is the source prototype. In this instance the source prototype is the JSAdapter object 440. The properties 434A-n and parents 460, 470, 480 can identify the corresponding parent objects 460, 470, 480 and/or specific properties 464A-C, 474A-C and 484A-C that are called when the corresponding object 430, 490 is executed.

The JSAdapter object 440 prevents a property (e.g. property2 434B) that is assigned to object 430 from changing the property in the parent classes 460, 470, 480, since doing so may violate the integrity of other, unrelated instances of those parent classes. By way of example, changing property12 434B of object class 430 will not affect the property22 464B in any of the parent classes 460, 470, 480. However, if property 464C of parent class 460 is modified, then all objects that call parent class 460 will be modified.

Once the JSAdapter object 440 is created by invoking a class creation function in a development environment, a developer can use the resulting class with the ordinary “new” statement in JavaScript, thereby achieving multiple inheritance functionality. A JavaScript function can also be used as a constructor. Because classes are functions, it is possible to define additional methods/properties on each of the classes with a “.prototype” syntax and gain all the benefits of multiple inheritance.

A library can also include the ability to define an initialization function on a class such that at instance creation time, the initialization function in the class itself and all of its superclasses will be called in a deterministic order dependent on the definition of the classes involved.

Single or multiple inheritance can be used in a JavaScript environment. In this manner, design patterns that involve inheritance can be applied directly, without the overhead of a manual translation into the prototype-based JavaScript object model. This functionality can also be used in single inheritance scenarios, without compromising in any way the ability to take advantage of multiple inheritance later as the application code evolves.

A function called “createClass” can take as arguments a list of base classes, which as mentioned in JavaScript, are functions and conventionally have a name starting with an uppercase letter, and returns the class to be defined.

By way of example: var Penguin=createClass(Bird, Piscivore); var p=new Penguin( ); Some desirable characteristics of a class are:

1) When looking up a property, if the property is not found then the class delegates the lookup to its superclasses in the order they were listed.

2) It is possible to add properties to a class and have them apply instantaneously to all the instances of that class (including instances of subclasses).

3) A method called “initialize” can also be defined for each class. When an instance is created, the initialize methods are run in a specified order: all initializers for the superclasses are run first, in reverse order with respect to the order they were listed, and only afterwards is the initialize method for the class itself run.

4) A class defines a property called “_super_” such that looking up a property in it is equivalent to performing the lookup in all the superclasses of the class, in the order they were listed.

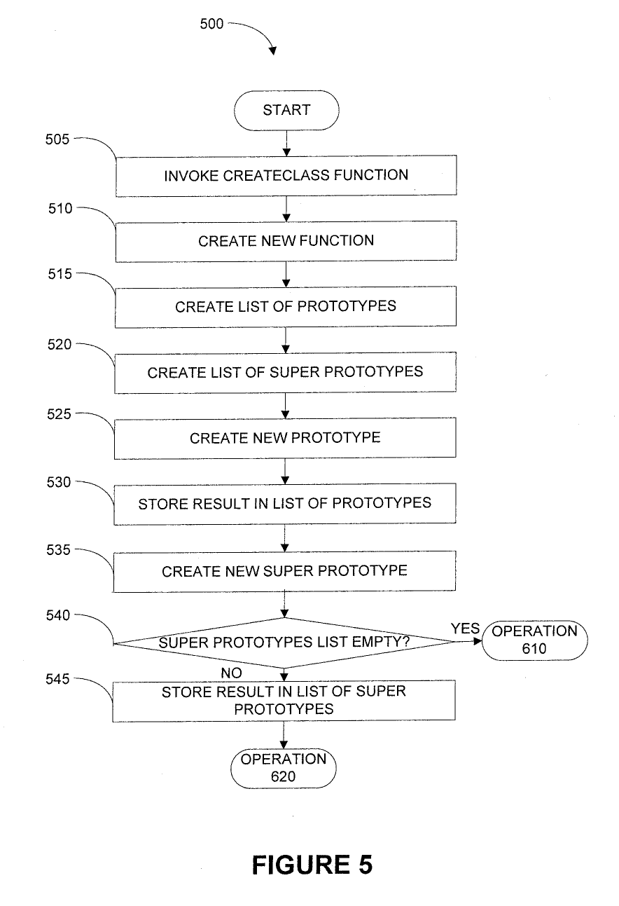

FIG. 5 is a flowchart of the method operations 500 for creating a class, in accordance with an embodiment of the present invention. In an operation 505, a “createClass” function can be invoked with a list of arguments C1, . . . , Cn (e.g., n superclasses).

In an operation 510, a new function is created. By way of example, “fn”, this function will be the newly created class. Creating a new object of type fn using the “new fn( )” syntax in JavaScript, fn will include an initialize method on the newly created instance. One embodiment of the code is the following:

var fn = function( ) {
this._{——}initialize_{——}.apply(this, arguments);
}

In an operation 515, a prototype list (e.g., “protos”) is created. The list “protos” includes fn.prototype and C1.prototype . . . Cn.prototype.

In an operation 520 a list of super prototypes (e.g., “superProtos”) is created. The each of the “superProtos” in the list of “superProtos” include the C1.prototype . . . Cn.prototype.

In an operation 525, a new prototype object is created by using new JSAdapter(makeDynamic(protos)). Where makedynamic is a function to be described in more detail below. The result is assigned to fn.prototype in an operation 530.

In an operation 535 a new super prototype object is created by using new JSAdapter(makeDynamic(superProtos)).

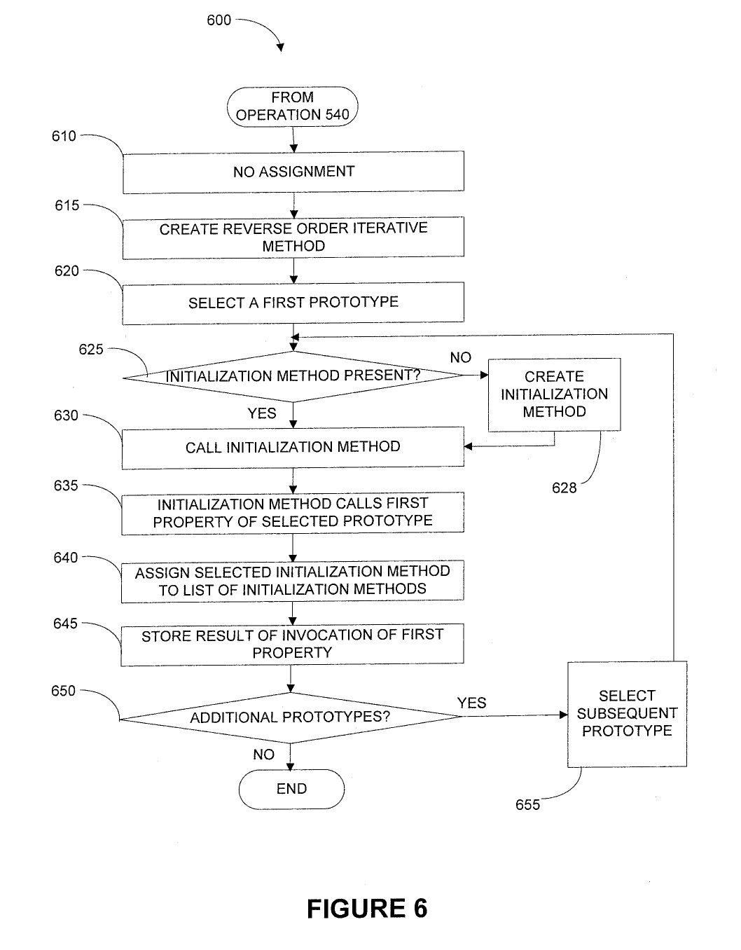

In an operation 540, the list of super prototypes is examined to determine if the list of super prototypes is empty. If the list of super prototypes is not empty, then the method operations continue in an operation 545. In operation 545, the result is stored in the list of super prototypes and the method operations can continue in Operation 620 of FIG. 6. If the list of super prototypes is empty, then the method operations continue in an operation 610 in FIG. 6.

FIG. 6 is a flowchart of additional method operations 600 for creating a class, in accordance with an embodiment of the present invention. In an operation 610, no assignment is made and the method operations continue in an operation 615. In operation 615 a reverse order iterative method is created. The reverse order iterative method will iterate in reverse order, each of the elements of the prototype except for the first element in each prototype.

In an operation 620 a prototype is selected. In an operation 630, the respective initialize method of the selected prototype is called, if present in the selected prototype, in operation 625.

In an operation 635, the initialize method of the first property of the selected prototype is called. In an operation 640, this initialize method is assigned to a list of prototype initialization methods (e.g., fn.prototype._initialize_). In an operation 645, a result (e.g., fn) is returned as the result of the “createClass” invocation.

If there are additional prototypes to be called in operation 650, then the method operations continue in operation 655 where a subsequent prototype is selected and the method operations continue in operation 625 above.

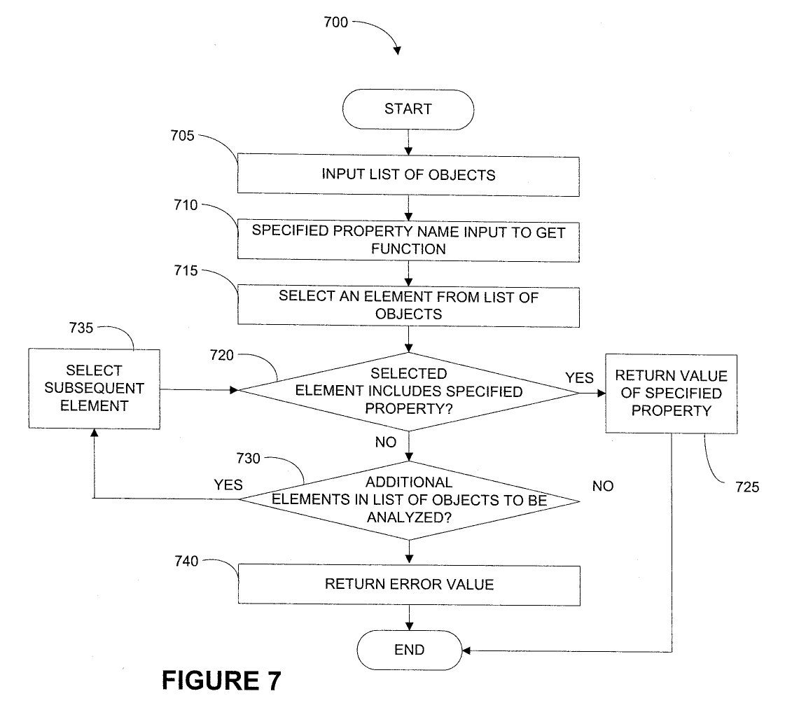

FIG. 7 is a flowchart of method operations 700 for dynamically calling a method, in accordance with an embodiment of the present invention. In an operation 705, a non-empty list of objects is input to a “makeDynamic” function.

In an operation 710, a desired function is specified using the JSAdapter, in such a way that when a property lookup occurs and a “get” method is called with the name of the specified property being sought. By way of example, if x is an object created using JSAdapter. Then when an expression such as x.y is evaluated the JavaScript runtime is going to call the “get” method of the object passed to the adapter with the string “y” as an argument. The “get” method will then compute the value of the “y” property in any way it sees fit and return it to the caller. In a further example, it could retrieve the value from another object, or from a database, or over the network or any location identified. This is in contrast with typical JavaScript objects, for which x.y implies looking up a value for y in the object x and return that value, without having the ability to compute the value on the demand.

In an operation 715, an element (e.g., object) of the argument list is selected for analysis. If in operation 720, the specified property is found in the selected object then in an operation 725, the corresponding value of the specified property is returned and the method operations can end.

If in operation 720, the specified property is not found in the selected object then the method operations continue in an operation 730. If in operation 730, there are additional objects to be analyzed then a subsequent object is selected in an operation 735 and the method operations continue in operation 720.

If in operation 730, there are no additional objects to be analyzed then the method operations continue in an operation 735. In operation 735, an undefined is returned since no object in the argument list satisfies the condition and the method operations can end.

Additionally, the object created by makeDynamic can also dynamically set/modify property values in the object. The corresponding method from JSAdapter is _put_. When a property assignment occurs, the _put_ function is called with the property name and value as arguments. The property can be set in the first object in the argument list (i.e. when setting properties, there is no iteration over the argument list whatsoever).

By way of example, assume x is an object created using JSAdapter. When a statement such as x.y=5; is executed, the JavaScript runtime will call the “put” method of the object passed to the adapter with two arguments, the string “y” and the value 5. The “put” method will store the value internally in anyway it sees fit. In a further example, the value could be stored in another object, or a database, or sent over a network. In contrast, a typical behavior of a JavaScript assignment statement of that form would be to set the property “y” of x to 5, but with the JSAdapter the “put” method is not limited to that operation.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Embodiments of the present invention can be processed on a single computer, or using multiple computers or computer components which are interconnected. A computer, as used herein, shall include a standalone computer system having its own processor, its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code and/or logic on a computer readable medium. The computer readable medium is any data storage device that can store data which can thereafter be read by a computer system. Examples of the computer readable medium include hard drives, network attached storage (NAS), logic circuits, read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

### Exemplary JavaScript Language Extensions Code

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of creating a class with multiple inheritance comprising:
invoking a create class function;
creating new function;
creating list of prototypes;
creating list of superprototypes;
creating a new prototype;
storing result in list of prototypes;
creating a new superprototype;
storing the new superprototype in the list of superprototypes when the list of superprototypes is not empty;
creating a reverse order iterative method;
selecting a first prototype; and
calling an initialization method when the initialization method is present in the selected prototype and creating the initialization method when the initialization method is not present in the selected prototype; and
assigning the selected initialization method to a list of initialization methods.

2. The method of claim 1, wherein the initialization method is operative to automatically call a first property of the selected prototype.

3. The method of claim 1, further comprising selecting a subsequent prototype when there is at least one additional prototype to analyze.

4. The method of claim 1, further comprising:
inputting a list of objects;
specifying a property name and inputting the specified property name to a get function;
selecting an element from a list of objects;
returning a value of the specified property when the selected element includes the specified property and selecting a subsequent element to analyze when the selected element does not include the specified property and additional elements in list of objects remain to be analyzed.

5. The method of claim 4, further comprising returning an error when there are no additional elements in list of objects remain to be analyzed.

6. The method of claim 1, wherein the method is a JavaScript method.

7. A computer system comprising:
a processor;
a memory system coupled to the processor by a data bus;
logic for invoking a create class function;
logic for creating new function;
logic for creating list of prototypes;
logic for creating list of superprototypes;
logic for creating a new prototype;
logic for storing result in list of prototypes;
logic for creating a new superprototype;
logic for storing the new superprototype in the list of superprototypes when the list of superprototypes is not empty;
logic for creating a reverse order iterative method;
logic for selecting a first prototype; and
logic for calling an initialization method when the initialization method is present in the selected prototype and creating the initialization method when the initialization method is not present in the selected prototype; and
logic for assigning the selected initialization method to a list of initialization methods.

8. The computer system of claim 7, further comprising
logic for inputting a list of objects;
logic for specifying a property name and inputting the specified property name to a get function;
logic for selecting an element from a list of objects;
logic for returning a value of the specified property when the selected element includes the specified property and selecting a subsequent element to analyze when the selected element does not include the specified property and additional elements in list of objects remain to be analyzed.

9. The computer system of claim 7, further comprising a JavaScript language development environment.

10. The computer system of claim 7, further comprising a library including functions, prototypes and superprototypes.
